(19) United States
(12) Patent Application Publication
(10) Pub. No.: US 2001/0037259 A1
(43) Pub. Date: Nov. 1, 2001

(54) System and method for rapid ordering of business supplies

(76) Inventors: Sameer Sharma, Springfield, NJ (US); Naresh Belwal, Staten Island, NY (US)

Correspondence Address: Thomas D. MacBlain, Gallagher & Kennedy, 2575 E. Camelback Road, Phoenix, AZ, 85016, US

(21) Appl. No.: 09/834,374

(22) Filed: Apr. 13, 2001

Related U.S. Application Data
(60) Provisional application No. 60/203,413, filed on May 11, 2000.

(51) Int. Cl. G06F 17/60

(52) U.S. Cl. 705/26

(57) ABSTRACT

Methods, computer programming, systems and devices that enable an office purchaser or a homeowner to regularly reorder supplies using a profile established on an administrator's website servers. Using a personalized list of supplies to place orders, a client identifies needed items by (a) scanning an appropriate barcode on a personalized list, (b) calling up and marking a profiled list maintained at the administrators website and/or adding or subtracting items using keyboard or mouse. The software installed on a client's computer runs silently as background as other programs are executed, but comes forward when a barcode is scanned or another input summons the program.

### FIELD OF THE INVENTION

This invention relates to methods, computer programming, systems and devices for ordering of supplies, and more particularly, to methods, programming systems and devices that facilitate ordering of supplies regularly replenished by a home or business.

### BACKGROUND OF THE INVENTION

Repeated purchasing of consumable supplies by the individual consumer or by a business is time consuming and tedious. As used here, “supplies” means any item regularly purchased and then exhausted by a business or private consumer. Even using a personal computer to order supplies via the Internet is time consuming and often troublesome. The person with that responsibility (the “buyer”) encounters busy signals, abrupt terminations and bizarre messages that may lead to frustration and eventual loss of sufficient interest to make the necessary attempts. Furthermore, one successfully connecting to the Internet is presented with myriad confusing sites and choices. Locating the sites needed and making the purchases in real time can be slow, when in fact, the actual transaction requires little time at all. If one wants to do comparative shopping, that can consume time even with the fastest of modems. Consequently, there is needed a simple, fail-safe and trouble-free system for repeated supply ordering via computer, telephone or other communications device.

Because consumable supplies must regularly be reordered, a buyer no sooner completes the ordering process when it seems, she or he must start over. It would be desirable to relieve the individual who has that responsibility of the need to repeat the same ordering steps each time a particular supply is needed. Most homes, and many businesses, do not have means of maintaining a record of supplies consumption that would enable better prediction of needs, cost saving quantity purchases, waste elimination and other cost saving measures.

The current state of the office supply system in most offices around the country if not around the world is a fertile ground for innovative change. The current system is often run in a mismanaged and an antiquated manner. A typical example is the office secretary keeping a list of the most commonly used suppliers and supplies in a place that is most often known only to her or him. She or he often uses manual methods of determining that they need to replenish certain supplies and uses the plain old phone system to call up the supplier and place the order.

Another example is the use of web enabled e-commerce business-to-consumer applications. There, authorized personnel access a list of items from which some, but probably not all, supply choices are made and the resulting orders are fulfilled by the backend systems.

Various other processes have attempted to alleviate parts of the difficulties addressed above. For example, some business-to-business applications try to achieve the best prices by using regular or reverse auctions. Various mechanisms allow updating supply requests data from a buyer to a particular supplier's database. Also, studies of buyer patterns are used to derive useful interpretations including timely purchase reminders and cost saving information. However, none of the prior developments makes an attempt to combine all of these while minimizing or entirely eliminating the buyer-internet interaction.

### SUMMARY OF THE INVENTION

In accordance with this invention, a method and system of supply replenishment, along with programming and devices developed for use therein, significantly reduce the time that a client of the system administrator spends in this activity by eliminating or greatly reducing that client's need to order from various suppliers or to confront the internet. By tracking the client's history of purchases and automatically either reminding the client or automatically replenishing the supply, a preferred embodiment of the invention greatly reduces or entirely eliminates repetitive purchase procedures.

The client's time is conserved by making the ordering process simple and speedy. Voice recognition software or interactive voice response (IVR) can be used by a client to communicate her or his list of desired supplies. In one embodiment, a bar code scanner is used to develop, as a machine readable message, a list of desired supplies by scanning product identification bar codes from a hard copy list of products, from the product packaging or from a catalog or other product menu or ad. The machine readable message that is the list of supplies desired to be purchased is transmitted by a client's PC or other computerized communication device to a system administrator.

The hard copy, human-readable list of items with associated bar codes that a client uses to scan in an order is developed by the client making choices on-line to the system administrator's website where choices of supplies for various businesses and for home are arranged into classes and subclasses relating to the businesses or homes that use the service. For example, a doctor's office can look to a category of medical supplies broken down by specialties such as internal medicine, geriatrics, pediatrics, etc. The completed personally assembled list with scannable quality bar codes is compiled by the system administrator and sent by mail, by email or by high quality facsimile. It is thereafter used by the client as the input source for the client's most often ordered supplies.

The previously prepared client profile is kept at the administrator's servers. It may contain credit information, preferred delivery methods and other preferences. It is accessible on-line by the client. Using appropriate identification such as a password and ID, the client can access his or her profile from any computer, not just his or her office PC or LAN. Reports on past expenditures are available to the client. These may be generated locally on the client's own PC using the installed software, or at the system administrator's central installation. Newsletters and other information particular to the client's field of endeavor can be delivered from the administrator to the client. Other input devices than the bar-code scanner may be used to input desired items, place orders, and receive confirmations. Voice recognition and IVR have been mentioned. Palm size computers and other touch screen activated devices are suitable communication tools. Home or office computer parallel or serial ports can accommodate such devices as IR sensors presently available. Orders are placed by mouse or keyboard when accessing the central website while away from the bar-code scanner equipped office computer. Also, mouse and keyboard are used to add items to lists of supplies to be ordered, to mark and unmark listed items for purchase.

In one particular embodiment, the bar code scanner used by the client is equipped with a display and a manual indicator that may simply be a single push button. The scanner is coupled to a PC or to a dedicated communications device. The scanned bar code produces in the display an identification of the product. The manual indicator is used to confirm the addition of the product to the list of products to be purchased and also may be used to cause an order to be placed and to note confirmation of the order received from the system administrator.

In a particularly desirable embodiment, software on a client's PC runs as background, invisible to the client when using other programs, but brought to the foreground upon scanning a bar code with a bar code scanner. In this and other embodiments of the invention, the software loaded in the client's PC does not require the client to access the Internet. Rather, when the client indicates that his or her supply list is complete and purchases should be made, he or she turns to other tasks. The PC automatically makes the Internet connection and places the order.

In a preferred embodiment, the client software is delivered to the client on, for example, a CD. It is initialized by the client logging in, choosing a password and ID and recording needed information such as credit card data that will automatically be used when the software communicates with the administrator's servers via the Internet. A default profile dialog prompts the client to construct a default profile useful in future ordering by this client. Communication software enabling communication with the bar code scanner, for example, is provided by the CD or other means of supplying local software.

In one embodiment, the bar code scanner is a pen style scanner with the display as described and with a transceiver for wireless communication to and from a dedicated communications base unit that connects to the home or business telephone lines. Either radio frequency communication or infrared communication can link the scanner and base unit. As scanning is completed and confirmed, the client simply initiates transmission to the base unit from the scanner. The base unit then uses the PSTN to upload the request to the central computer installation that will do the purchasing for this and other consumers. A confirmation is returned and the bar code scanner display indicates that the order was recorded successfully.

In another embodiment, the dedicated communications base unit communicates to a client's computer as an input device. Uploading of purchase lists to the central computer installation is via the Internet, as is confirmation. Delivery of dedicated, pre-programmed communication devices can be the means for delivery of the client software, rather than the CD delivery or other software installation technique.

In one other embodiment, it is a small hand-held computer such as a PALM PILOT® that is used to execute supply orders. The computing power of these devices is of such magnitude that it is possible along with versions of operating systems like the Microsoft Windows CE to execute applications having a graphic user interface (GUI). A client can indicate which supplies he or she is seeking, and this can be communicated, for example, by infrared, either to a dedicated wireless receiver coupled as previously mentioned to phone lines, or to the client's PC for internet connection.

In a further embodiment, the client to central installation interface employs interactive voice response (IVR). Using this facility as the means of communicating the supply purchase list to the central installation, the client dials the central installation's toll free number and identifies herself or himself by punching in a pre-assigned ID number. The IVR system then guides her or him through her or his previously established default profile, prompts for ordering instructions via the telephone key pad, and also notes any deviation from the default choices previously made.

In both the bar code scanner and wireless hand-held computer device embodiments, transferring the order to the central computer installation is accomplished by the client software automatically dialing out to the client's internet service provider, if one exists for the client in question, or by dialing out to a toll-free bank of lines set up by the system administrator. Of course, in the case of an office with high speed internet access through a LAN or otherwise, dialing out is unnecessary to reach the central installation of the system administrator.

Once connected, the client's installation sends out a short burst of encrypted and compressed data to the central server or computer installation, which records this and sends an acknowledgement back. Upon receipt of the acknowledgement, the client's application automatically terminates the call and records locally that the order was successfully transferred.

With the wireless bar code pen style scanner and dedicated base unit connected to telephone lines, the telephone system is used to reach a toll-free number. Upon successful connection, a short burst of encrypted and compressed data again facilitates the transfer of the order to the central installation. If all is in order, a confirmation is sent by phone to the client before terminating the call.

In the case of the IVR method mentioned above, there is no separate step of reaching the central server or computer installation as this is subsumed in the IVR interchange between the client and the central installation. The IVR system will update the database and record the choices of the client.

In all instances, the central installation will then proceed in the order-processing step.

At the central installation, the supply requests from clients are recorded and aggregated, product by product. Reverse auctioning of the thus-aggregated item yields price advantages that can be passed along to the individual clients. If desired, however, other criteria can form the basis for a purchase. These criteria may be specified by the client. These may include time of delivery, cost of delivery, reliability of the supplier, quality history, and other terms of sale.

Delivery of the purchased supplies is effected by the supplier directly delivering to the clients. Alternatively, of course, the central facility administrator may take delivery or even warehouse supplies based on anticipated sales where sale histories have made purchases predictable. A “rapid response” fulfillment/delivery system is an option based on inventory being held at the central installation warehouse or by special arrangement with reliable suppliers.

Over a period of time, data gathered based on sales can contain a variety of useful interpretations. The central installation administrator can warehouse all data and use it commercially. Data, thus gathered, can be used to provide clients that have subscribed with periodic reports of usage patterns, reminders, or even an automatic refilling of supplies without the need for reordering. The data gathered on the basis of purchases can be an additional income source for the administrator of this system. The data can be used to produce highly targeted advertising of supplies to those who have regularly purchased in the past. Information concerning new products can be made available to targeted clients based on this information.

Benefits that are available to clients using this system can include the ability to personalize the choice of supplies or suppliers for a particular selection of products or product brands. The client can take advantage of the best prices at a given point of time, either from the client's select list of suppliers or from the entire supplier universe available to the system administrator. The client has the further price reduction advantage of the reverse auction process as well as the quantity discount that becomes available through the aggregation of like items. Over a period of time, clients can be made aware of better purchasing options and sales opportunities on items of regular purchase by virtue of their purchase history being known to the system administrator. Clients can rely on the system administrator for the purpose of reordering as item-usage history becomes established. The system lends itself to improved record keeping either locally or by the system administrator. Clients can generate personalized, detailed lists of purchases for easy reordering. Clients are able to generate reports that detail their history of purchasing in order to more efficiently operate their businesses or homes. Clients can readily introduce changes in their default list of items and their default list of suppliers.

The system of the invention eases the managing of general office supplies as well as supplies specific to the business. This means a single point of ordering supplies, which results in a reduction in transaction costs and an increase in the efficiency of the supply chain mechanism.

The above and further advantages of the invention will be more clearly understood with reference to the following detailed description taken in combination with the accompanying drawings.

### BRIEF DESCRIPTION OF THE DRAWINGS

FIG. 1 is a block diagram illustrating a system for supplies replenishment utilizing the Internet.

FIGS. 1a-1d are block diagrams illustrating a number of different client input arrangements for communicating supply needs to a central installation.

FIG. 2 is a schematic illustration of the relationship among suppliers, clients, and a central system administrator.

FIG. 3 is a state diagram indicative of the operation of the system for supply replenishment.

FIG. 3a is a flowchart illustrating a routine for the communication of a request by a client.

FIG. 3b is a flowchart illustrating a request for a report on past supply purchase activities by a client.

FIG. 3c is a flowchart of the generation of a request by a client utilizing a default profile previously established.

FIG. 4 is an illustration of a portion of a display indicating a supplies ordering icon named “Smart Buyer.”

FIG. 5 is an illustration of a display screen that presents itself as the user interface upon detection of an event such as a barcode scan.

FIG. 6 is a diagrammatic illustration in the form of two display screens, the first being a profile previously established and used by a client to assemble a list of supplies to be purchased, and the second being the list so-assembled.

FIG. 7 is a diagrammatic illustration or flow chart indicative of the interaction of the client, system administrator and a supplier.

### DETAILED DESCRIPTION

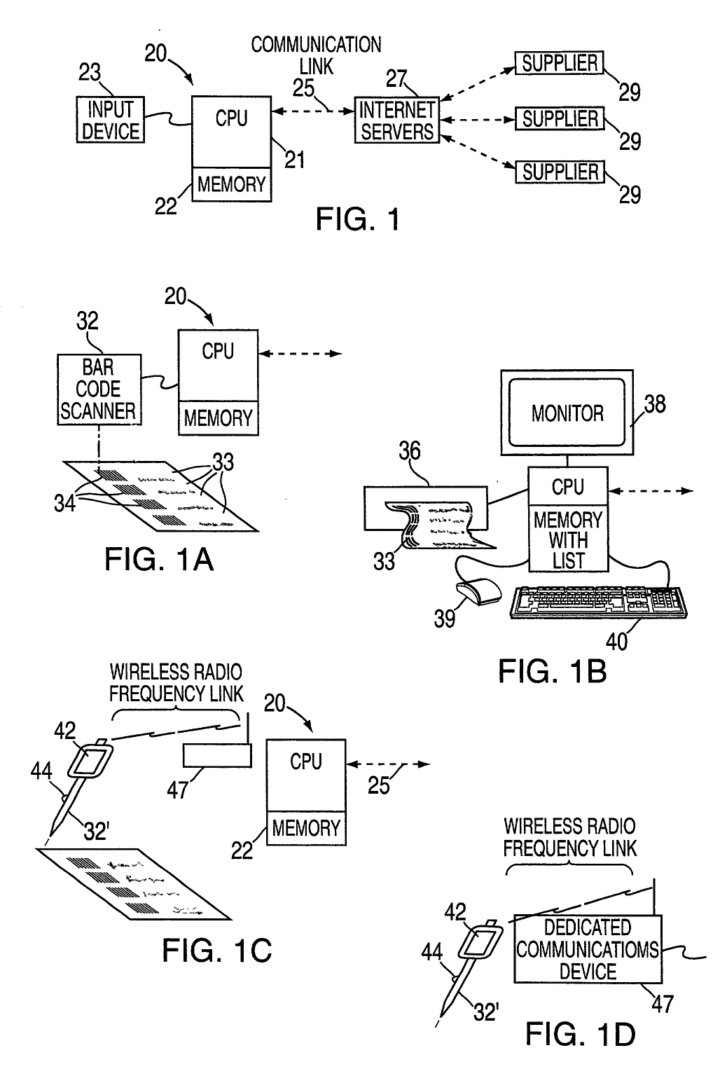

Turning to FIG. 1, in a preferred embodiment, at a client's site a computer 20 has a CPU 21 and memory 22. It is equipped with an input device 23. Together these function as a communication device by which the client communicates via a communication link 25 to Internet servers 27 provided by the system administrator. Using software delivered to the client by the system administrator in any convenient fashion, for example on a CD, the client places a list of supplies on the computer 20. When instructed, then, the software communicates the list via Internet to the Internet servers 27. There, the administrator aggregates like supplies and, by reverse auction, asks for bids via the Internet. Suppliers respond via their computers 29.

As shown in FIG. 1a, the input device that a client uses to indicate the supplies to be purchased may be a bar code scanner 32. This is used in connection with a hard copy list 33 of supplies; each associated with a set of bar codes 34.

In one embodiment as shown in FIG. 1b, the computer 20 is equipped with the programming that the client uses to assemble and print, at a printer 36, the list 33. Working with a monitor 38, a mouse 39 and a keyboard 40, the client assembles a supply list particular to the client's home or business without connecting to the Internet.

In FIG. 1c a bar code scanner 32′ is a pen-like device equipped with a LCD display 42 and a push button or clicker 44. The bar code scanner 32′ is also equipped with a low power radio frequency transceiver that communicates the list of products to a transceiver 47 connected to the computer 20 via, for example, its serial port. The computer 20 uploads the assembled list of supplies via the Internet to the central administrator's Internet servers 27 in the manner of FIG. 1. In a further preferred embodiment, FIG. 1d, the pen-like scanner 32′ communicates with a dedicated communications device 47, which includes a transceiver and computer circuitry and memory sufficient to enable its communication of the assembled list of supplies via telephone or the internet.

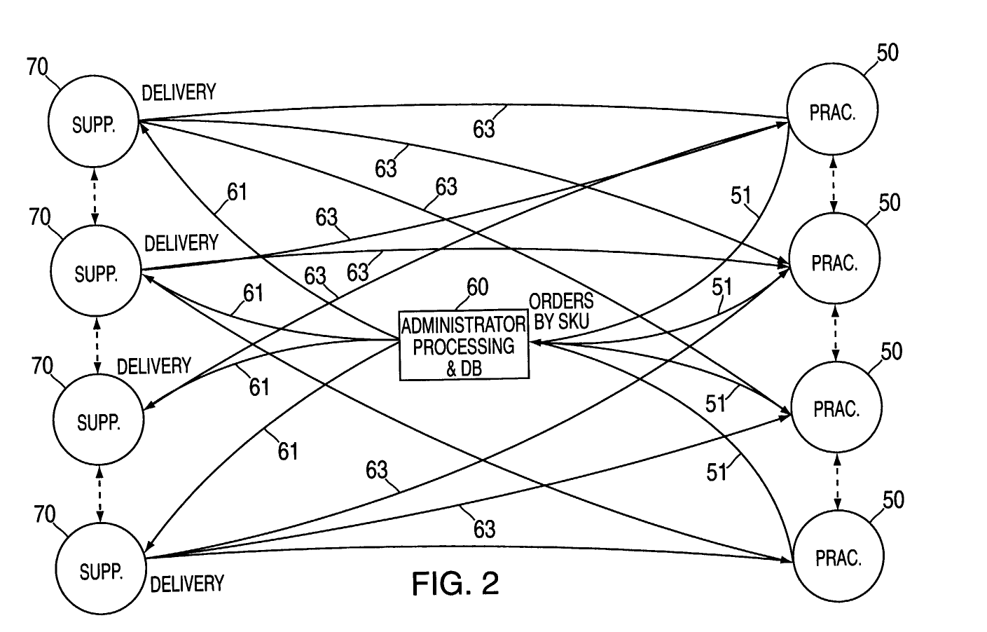

As shown in FIG. 2, the relationship among the clients 50, the central administrator 60 and the suppliers 70 is such that orders placed by the clients 50 all are received at the central administrator's facility where they are aggregated, for example by SKU number. These are posted for bids as indicated at 61. The central administrator 60 selects the suppliers with winning bids, and these suppliers deliver supplies directly to the clients as routed by the central administrator, as indicated at 63.

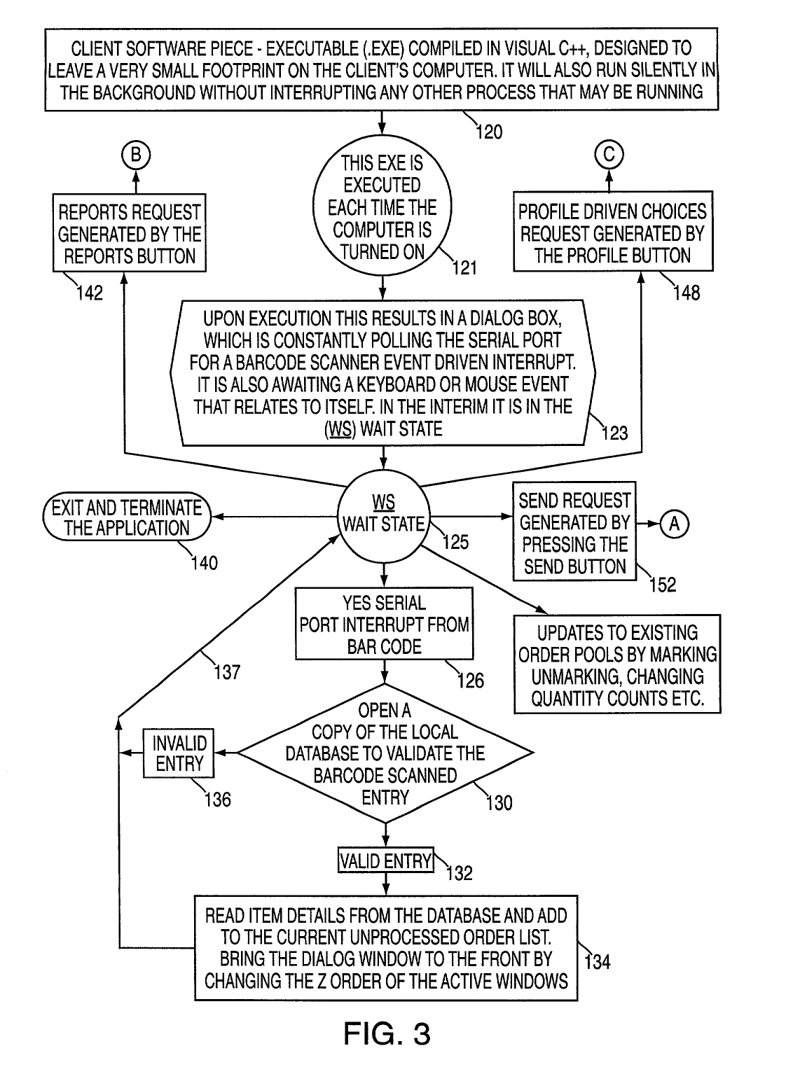

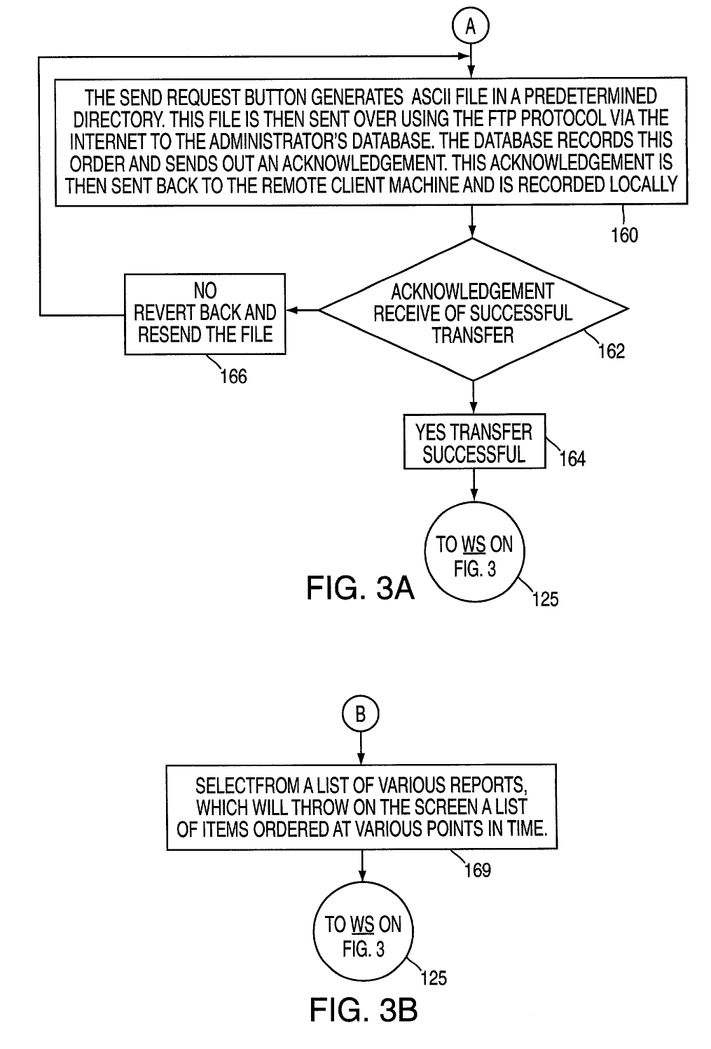

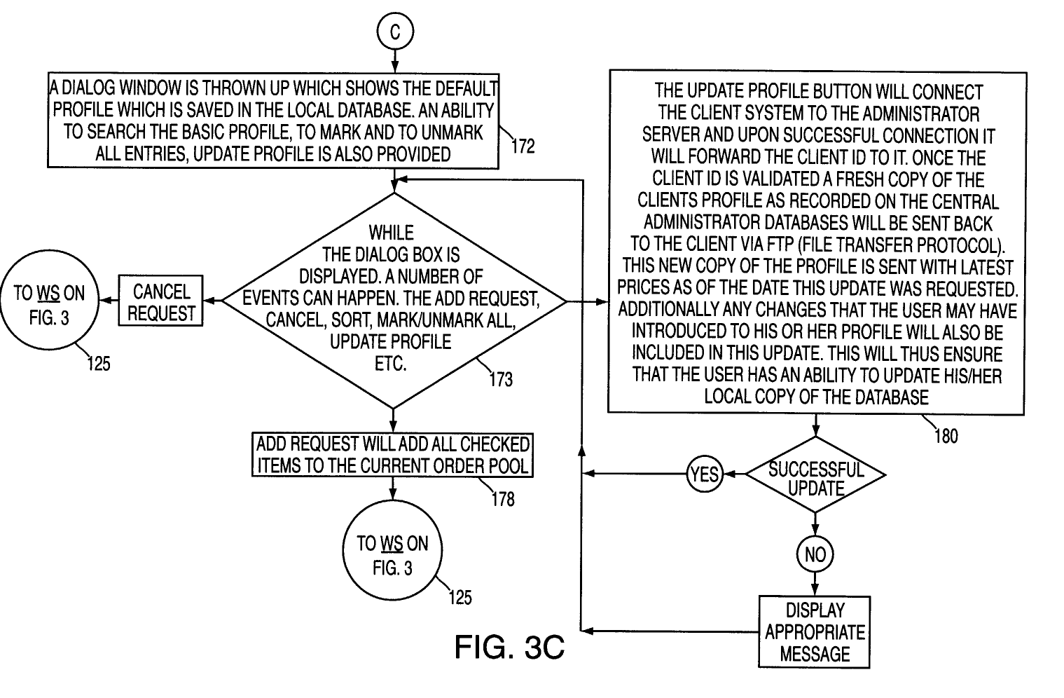

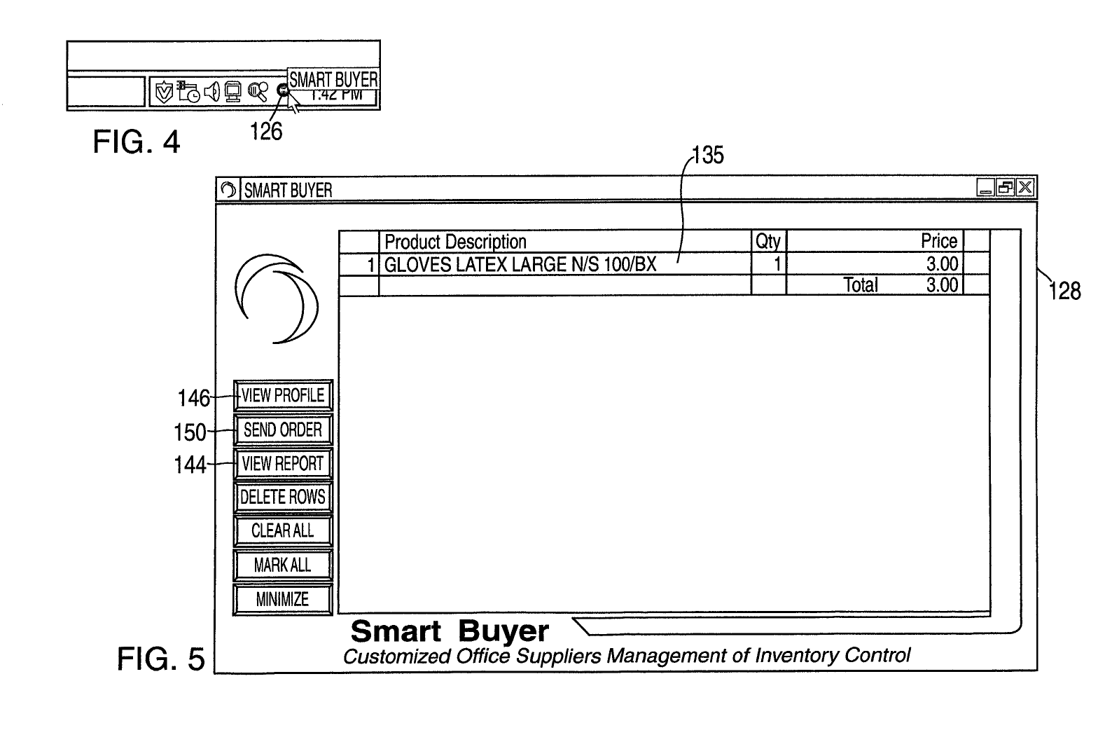

As shown in FIG. 3, clients' software distributed by the central administrator is in executable files compiled in Visual C++, designed to leave a very small footprint on the client's computer. All of this is as indicated at 120. This “.EXE” is executed each time the computer is turned on as indicated at 121. As at 123, the programming constantly polls the serial port/keyboard for an interrupt, from an input device such as the bar code scanners 32 and 32′, the mouse 39 or the keyboard 40 of FIGS. 1a-1d. While awaiting an input event relating to the supplies replenishment software, this programming is in a wait state 125. In the wait state, the programming waits as background while other programming may be executing. Only a small icon 126 (FIG. 4) appears on the system tray of the screen of the monitor.

In this mode the supplies replenishment software is always running, but in a silent unobtrusive manner, without affecting any other applications. It is quietly waiting to be activated by the user with the bar code scanner, the mouse or the keyboard. When the user picks up the scanner and scans in the bar code of a desired item, an interrupt as indicated at 126 of FIG. 3 causes a screen 128 of FIG. 5 to be displayed. The software opens a copy of the local database to validate the bar code scanned entry at 130 of FIG. 3. If the entry is valid as at 132, then details from the database are read and added to the current unprocessed order list, and the screen 128 of FIG. 5 is brought to the front by changing the Z order of the active windows, as at 134 of FIG. 3. In FIG. 5 the scanned entry is shown at 135. In this case it is one pair of latex gloves priced nominally at $3.00.

In the case of an invalid entry the software loops back to the wait state as indicated at 136 and 137. The dialogue window that is the screen 128 is used as well to exit and terminate the application as shown at 140 in FIG. 3. A client requests a report by activating the reports button 144 of the screen 128, indicated at 142 of FIG. 3. Depression of the view profile button 146 (by clicking on it) enables the profile driven choices as indicated at 148 of FIG. 3. Similarly, activation of the send order button 150 moves the program to the send request subroutine as indicated at 152 of FIG. 3.

Turning to FIG. 3a, activation of the send order button 150 of the screen of FIG. 5 generates an ASCII file in a predetermined directory. This file is sent over to the central administrator's servers using the FTP protocol via the Internet. The central administrator's database records this order and sends out an acknowledgment. The acknowledgment is received by the remote client and is recorded there, all as indicated at 160 of FIG. 3a. Locally if the acknowledgment is received as indicated at 162, the software moves to the wait state 125 as indicated at 164. If the acknowledgment is not received then, as indicated at 166, the program loops back and sends the request again.

Activation of the view report button 144 of the screen 128 of FIG. 5 brings onto the screen a report selected from a list of such reports. It lists items ordered by the client at various points in time as indicated at 169 in FIG. 3b.

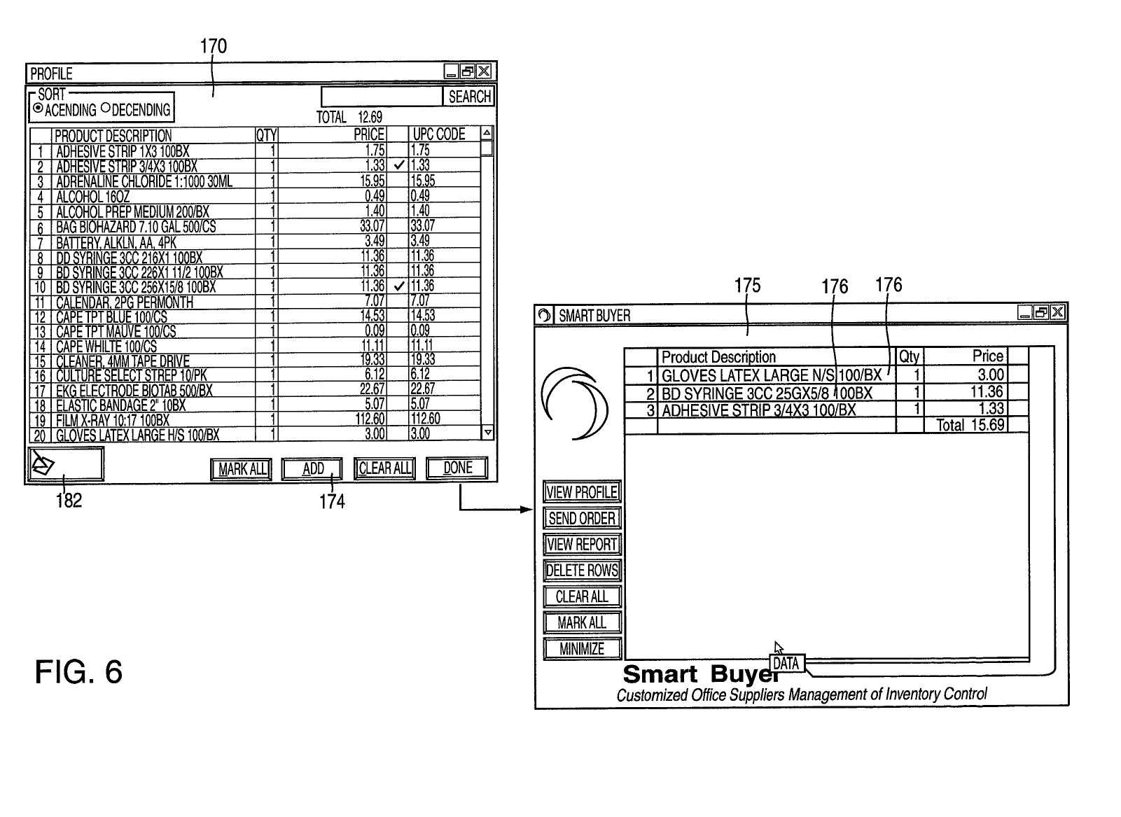

Activation of the view profile button 146 of the screen 128 of FIG. 5 opens a dialogue window, which is the screen 170 of FIG. 6. This screen contains a default profile saved in the local database. It provides the local client the ability to search the profile, to mark and unmark all entries and update the profile as indicated at 172 of FIG. 3c. As indicated by the decision block 173 of FIG. 3c while the dialogue window 170 is open, a number of events can happen. The client can add a request by activation of the add button 174 shown in FIG. 6. This will cause all checked items to be added to the current list of supplies as indicated in the fields 176 of a window 175 shown in FIG. 6. The add request routine is indicated at 178 in FIG. 3c.

As indicated at 180 in FIG. 3c, activation of the update profile button 182 of screen 170 in FIG. 6 connects the client system to the central administrator's servers and sends the client ID to the central administrator. Upon validation, the central administrator's server sends the client's profile to the client via FTP. The profile sent is a new copy with latest prices as of the date of the request. Additionally, any changes that the client may have introduced to his or her profile will also be included in the update. This insures that the client has the ability to update his or her local copy of the database.

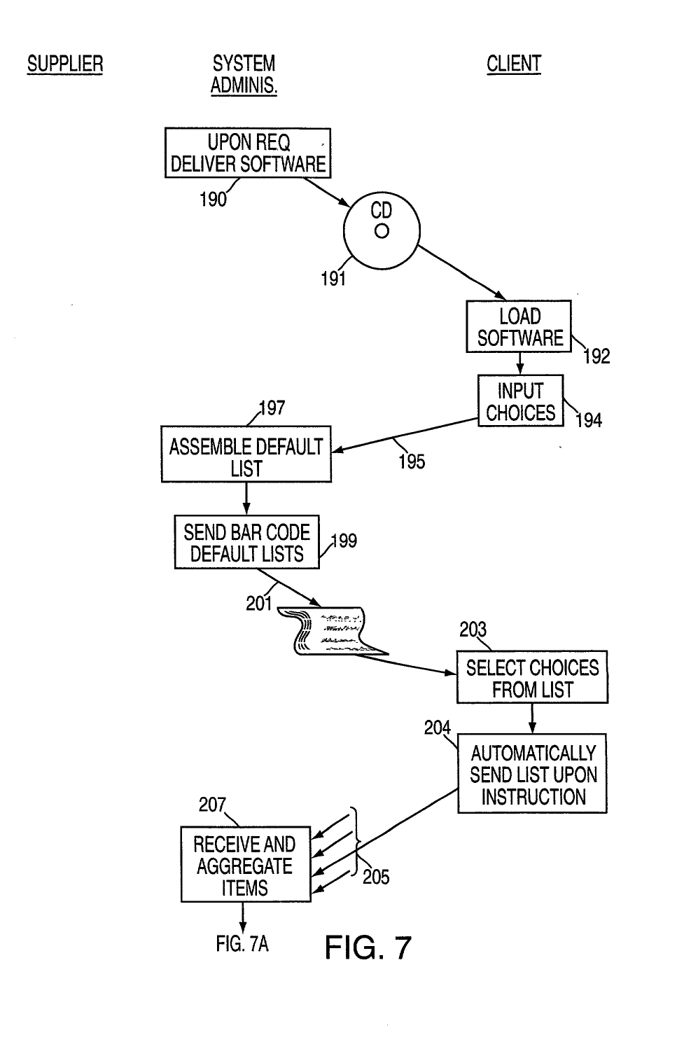

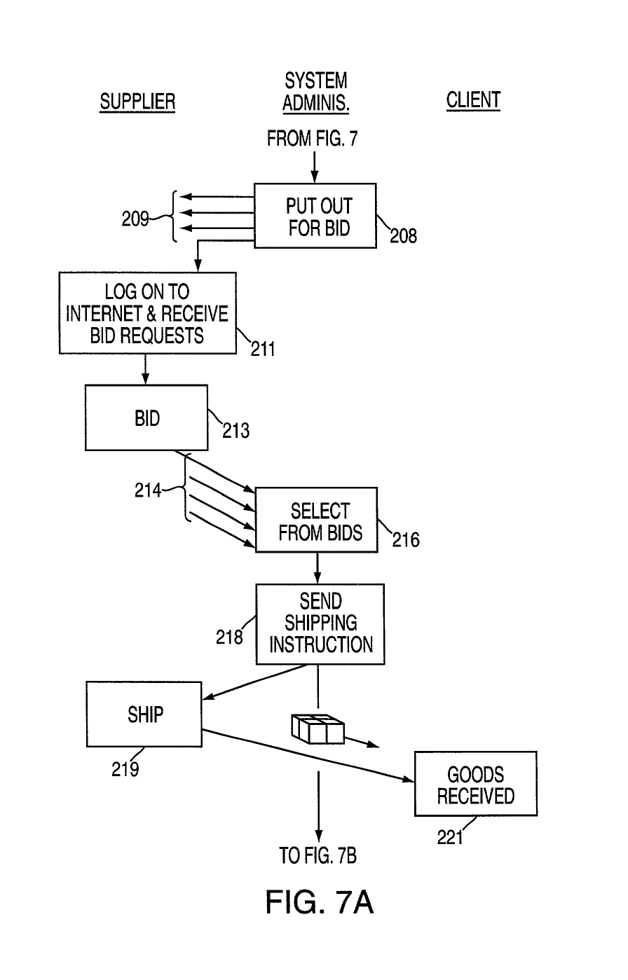

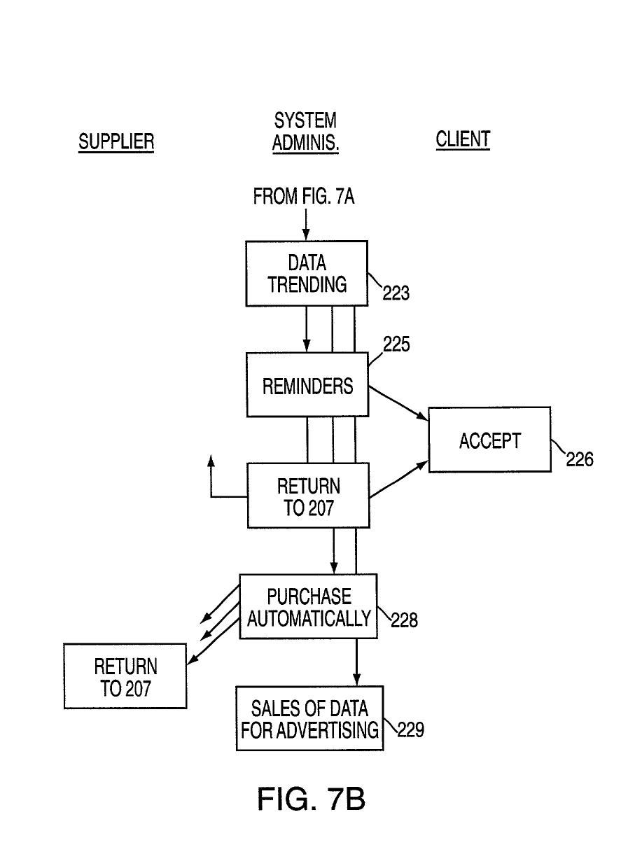

FIG. 7 charts a typical exchange among system administrator, client and supplier. At 190, upon the request of a client, software is delivered, for example, by sending a CD 191 to the client who then loads that software at 192 into his or her PC. The client inputs his or her choices of supplies to regularly be ordered via the system at 194. These are sent to the system administrator at 195 where they are assembled into a default list at 197. From the selected supplies, the system administrator prepares the bar-coded default list at 199 and forwards that at 201 to the client.

To order supplies, the client selects choices from the bar-codes on the list at 203. Upon completion of the desired purchases, the list is automatically sent at 204 to the system administrator who aggregates similar requests 205 as indicated at 207.

In a reverse auction, the system administrator puts out the aggregated supplies via Internet for bid as indicated at 208 and 209.

At this point, as at 211, a supplier logs on via the Internet and receives the bid requests posted at 208. A bid is submitted at 213 and from among the submitted bids 214, the system administrator selects winning bids at 216. At 218, shipping instructions are sent by the system administrator to the supplier. The supplier ships at 219 to the client at 221.

In addition, the system administrator performs data trending at 223 using the purchase data from the clients. The system administrator can forward reminders to the clients at 225 allowing them to fill supply requirements simply by accepting them at 226. Upon receipt of an acceptance, the system administrator operates as previously described upon receipt of orders at 207, aggregating the items and performing the steps shown at 208, 216 and 218.

Alternatively, the system administrator, based on the data trending performed at block 223 may, at 228, purchase automatically supplies determined to be regularly purchased by the client, returning to block 207 to perform again the aggregation of items and the reverse auctioning of 208, etc.

Finally, an option open to the system administrator is the sales of data simulated in the data trending step 223 as indicated at 229.

While preferred embodiments of the invention have been described in detail above, it will be apparent to those skilled in the art that modifications may be made without departure from the sprit and scope of the invention as set forth in the appended claims.

1. A method of regularly replenishing supplies comprising:
(a) providing at the site of a local computerized communications device a human-readable list of items;
(b) supplying in machine readable format to the local computerized communications device a message identifying items selected from the list with an instruction to purchase; and
(c) automatically, in response to step (b), causing the local computerized communications device to communicate electronically to a remote computer identifying the selected items, quantities of the selected items, and the identity of a purchaser.

2. The method according to claim 1, wherein step (c) includes communicating with the remote computer via the internet automatically as a software response to step (b).

3. The method of claim 1, further comprising associating with items on the list a machine-readable code.

4. The method according to claim 3, wherein associating with items on the list a machine readable code includes associating with items on the list a bar code uniquely identifying the items on the list, and step (b) includes scanning the bar codes of selected items to generate the message identifying selected items.

5. The method of claim 1, wherein step (b) comprises communicating via one of a voice recognition software, a wireless radio frequency link and an infrared link.

6. The method of claim 1, wherein step (b) comprises communicating via a wireless radio frequency link between a bar code scanner and a receiving circuit coupled to the local computerized communications device.

7. The method of claim 1, wherein step (b) comprises communicating via a wireless radio frequency link between a bar code scanner and a receiving circuit forming a part of a dedicated communications device.

8. The method according to claim 2, wherein the local computerized communications device comprises one of a personal computer, a LAN, a laptop computer, a palm-size computer, a smart phone, or a dedicated communications device.

9. The method according to claim 2, wherein communicating via the Internet comprises communicating via at least one of land-line telephony and wireless telephony.

10. The method according to claim 1, wherein providing a human-readable list of preferred supplies comprises scanning barcodes printed on items to be included in the list and communicating to the local computerized communications device the identity of the items.

11. The method according to claim 4, further comprising:
providing a display in association with a barcode scanner, and displaying thereon at least one of the identification of the item the barcode of which has been scanned, the quantity of the item being ordered, and confirmation of an order.

12. The method according to claim 1, further comprising:
providing and running programming on the local computerized communications device for responding to step (b) and causing the device to effect step (c), the programming being adapted to run in the background of other programs run on the local computerized communications device.

13. The method according to claim 12, wherein the programming has a wait state in which the program runs unobtrusively behind other active program or programs and is responsive to an interrupt to present an active user interface.

14. The method according to claim 13, wherein the interrupt is event driven by at least one of a barcode scanner event, a keyboard event and a mouse event for which the programming continually polls.

15. The method according to claim 14, further comprising:
validating a barcode scanned entry upon receipt of a barcode scanner driven interrupt and adding an item represented by the scanned barcode to a current list of unprocessed orders.

16. The method according to claim 14, wherein, in response to an interrupt, the programming presents a user interface having a send order activator.

17. The method according to claim 16, wherein, in response to activation of the send request activator, the programming causes the local computerized communications device to send to the remote computer the message identifying the selected items.

18. The method according to claim 17, wherein, after sending the message to the remote computer, the programming of the local computerized communications device awaits a confirmation, resends the message in the absence of a confirmation and communicates a successful transfer to a user upon receipt of a confirmation.

19. The method according to claim 14, wherein, in response to an interrupt, the programming presents a user interface having a reports activator operative to cause the local computerized communications device to make available to a local user at least one report relating to the local computerized communications device past activities using the programming.

20. The method according to claim 19, wherein, the at least one report relating to the local computerized communications device past activities using the programs includes a report listing a history of items ordered.

21. The method according to claim 17, wherein, in response to an interrupt, the programming presents a user interface having a default profile activator making available to a local user a profile selection.

22. A method of regularly replenishing supplies comprising:
(a) communicating by telephone from a central installation by interactive voice response (IVR) a selection of supplies to local clients' telephones,
(b) receiving by keyed-in responses from the local clients' telephones identifications of clients' choices of supplies from the selection of supplies,
(c) aggregating clients' choices of like supplies,
(d) by computer, via global computer network offering the purchase from suppliers of supplies thus aggregated, and
(e) routing purchased supplies from suppliers to clients.

23. The method according to claim 22, further comprising:
gathering and storing records of purchases by clients and determining, based on the gathered and stored records, clients' projected needs for replenishment of supplies.

24. The method according to claim 23, further comprising:
notifying clients of determined, projected needs for supplies as arrived at from the gathered and stored records.

25. The method according to claim 23, further comprising:
automatically purchasing clients' determined, projected needs for supplies as arrived at from the gathered and stored records.

26. The method according to claim 23, further comprising:
offering for sale information accumulated from records gathered and stored.

27. A computer program comprising, in a tangible medium:
(a) programming responsive to encoded inputs operative to cause a local computerized communication device to prepare a list of user-selected items,
(b) further programming for automatically causing the local computerized communication device to connect with a remote computer installation electronically and to communicate the list of user-selected items and further data to the remote computer installation as an order for purchase of the selected items, and
(c) additional programming to await a confirming message from the remote computer installation and to produce a confirming communication for a client.

28. The computer program according to claim 27, wherein the further programming for automatically connecting comprises routines for connecting to the internet and for addressing the remote computer installation in response to a send signal input by the user.

29. The computer program according to claim 28, further comprising:
programming operative to cause the computer program to run as background to one or more other active programs running on the local computerized communications device, and input polling programming operative to bring the computer program to run as foreground upon detecting an input.

30. The computer program according to claim 27, further comprising:
programming responsive to an input from a barcode scanner scanning a product identification code of an item to add that item to the list of user-selected items.

31. The computer program according to claim 29, further comprising:
programming responsive to an input from a barcode scanner scanning a product identification code of an item to cause the computer program to run as foreground and to add that item to the list.

32. The computer program according to claim 27, further comprising:
programming operative to generate a list of items and associated barcodes for use by a client in communicating to the local computerized communication device to input items to be purchased using a barcode reader.

33. The computer program according to claim 27, further comprising:
voice recognition programming.

34. The computer program according to claim 27, further comprising:
interactive voice response programming.

35. The computer program according to claim 27, further comprising:
programming operative to store in memory records of purchases using the computer program.

36. The computer program according to claim 35, wherein the programming operative to store in memory records of purchases further includes report generation routines for the preparation and presentation of reports based on the records of purchases.

37. The computer program according to claim 27, further comprising:
programming responsive to profile dialog input for bringing up on a monitor screen a dialog on a default profile.

38. The computer program according to claim 35, further comprising:
programming operative to generate a reminder based on the records of purchases.

39. The computer program according to claim 38, wherein the programming operative to generate a reminder comprises program routines and data storage for predicting need for a regularly purchased item based on history of purchases of the items.

40. The computer program according to claim 27, further comprising:
programming enabling the local computerized communication device to communicate between the remote computer and a local reader device.

41. The computer program according to claim 40, wherein the local reader includes a display, the programming enabling the local computerized communication device to communicate comprising routines operative to effect display of the confirming message from the remote computer on the display.

42. The computer program according to claim 41, wherein the programming enabling the local computerized communication device to communicate comprises routines enabling the local computerized communication device for wireless communication with the local reader device.

43. The computer program according to any one of claims 40-42, wherein the local reader comprises a bar code scanner and the programming enabling the local computerized communications device to communicate comprises routines enabling the derivation of product identification information from bar codes.

44. A method of operating a centralized supply order processing site, including:
(a) receiving from a plurality of client computers orders for lists of supplies,
(b) aggregating like supplies from the lists,
(c) offering electronically by global computer network purchases of the supplies thus aggregated,
(d) receiving electronically by global computer network offers to sell the supplies identified in step (c),
(e) ordering the supplies from selected responding suppliers,
(f) routing the supplies in quantities originally ordered in step (a) to ordering clients, and
(g) charging the clients for the supplies routed to them.

45. The method of operating a centralized supply order processing site according to claim 44, further comprising:
prior to step (a), distributing to clients programming for a local computerized communications devices for electronically assembling and sending via global computer network the lists of supplies.

46. The method of operating a centralized supply order processing site according to claim 45, wherein the programming distributed to clients includes bar code recognition programming for deriving the lists, at least in part, from product identifying bar codes.

47. The method of operating a centralized supply order processing site according to claim 45, wherein the programming distributed to clients includes programming automatically connecting the local computerized communications device to connect automatically and transparently to the internet as the result of a client completing a list of desired supplies.

48. The method of operating a centralized supply order processing site according to claim 45, wherein the programming distributed to clients includes voice recognition programming for deriving the lists, at least in part, from product identifying vocal commands.

49. The method of operating a centralized supply order processing site according to claim 44, wherein step (a) comprises receiving by interactive voice response (IVR) the lists of supplies.

50. The method of operating a centralized supply order processing site according to claim 49, wherein receiving by IVR includes presenting the client with a list of supplies for the client's response based on that client's past purchasing activities.

51. The method of operating a centralized supply order processing site according to either claims 44 or 47, further comprising:
(a) sending via global computer network confirmation messages to the clients' computerized communication devices acknowledging receipt of the lists.

52. The method of operating a centralized supply order processing site according to claim 44, further comprising:
assembling purchasing histories by maintaining a record of clients' supply lists received over a period of time, determining electronically the apparent frequency and quantity of at least one of the supplies on clients' lists.

53. The method of operating a centralized supply order processing site according to claim 52, further comprising:
forwarding a notice to a client in anticipation of that client's need for a supply item based on the determined frequency and quantity of past purchases of the at least one supply by that client.

54. The method of operating a centralized supply order processing site according to claim 52, further comprising:
automatically effecting steps (b) through (g) based, at least in part, on the determined frequency and quantity of past purchases of the at least one supply by that client.

55. The method of operating a centralized supply order processing site according to claim 52, further comprising:
making available the purchasing histories to third party suppliers or advertisers of items likely to be purchased.

56. The method of operating a centralized supply order processing site according to claim 45, wherein distributing programming comprises distributing programming operative to run as background to one or more other active programs on the local computerized communication device.

57. The method of operating a centralized supply order processing site according to claim 56, wherein the programming operative to run as background comprises includes polling programming operative to bring the computer program to run as foreground upon detecting an input.

58. The method of operating a centralized supply order processing site according to claim 44, wherein step (e) comprises selecting a supplier based on at least one of price, delivery time, quality of product and reliability of supplier.

59. The method of operating a centralized supply order processing site according to claim 45, wherein distributing to clients programming comprises providing programming in a dedicated communications device.

60. The method of operating a centralized supply order processing site according to claim 44, further comprising:
at least one of communicating and receiving by the global computer network, further, non-price terms for the delivery of supplies.

61. The method of operating a centralized supply order processing site according to claim 60, wherein the non-price terms include at least one of delivery cost, carrier, and delivery schedule.

62. The method of operating a centralized supply order processing site according to claim 44, further comprising:
providing a database of product identifications accessible by remote clients via global computer network, and
assembling and forwarding to a client a list of supplies as identified from the database by that client.

63. The method of operating a centralized supply order processing site according to claim 62, wherein providing a database of product identifications comprises classifying product identifications by business and non-business endeavors in which the products are used.

64. The method of operating a centralized supply order processing site according to claim 62, wherein providing a database of product identification comprises structuring the database in a system of classes and subclasses of product identifications.

65. The method of operating a centralized supply order processing site according to either claim 62 or 64, wherein assembling a list of supplies includes associating with a human-readable identification of each item selected by a client from the database a machine readable code identifying the item listed.

66. The method of operating a centralized supply order processing site according to 65, wherein the machine readable code is a barcode.

67. A computer program comprising, in a tangible medium:
(a) programming to aggregate in a central computer installation like supplies from lists of supplies input from remote client communication devices;
(b) further programming to offer, via global computer network, to purchase the supplies thus aggregated;
(c) additional programming to receive from remote suppliers offers to sell the supplies thus offered to be purchased;
(d) other programming to communicate to offering suppliers acceptance of an offer to sell; and
(e) still other programming to communicate to the suppliers instructions for delivery of the supplies among clients from whose lists the supplies have been aggregated.

68. The computer program according to claim 67, further comprising:
programming for receiving by interactive voice response the lists of supplies input telephonically from client telephones acting as the remote client communication devices.

69. The computer program according to claim 67, further comprising:
programming for receiving the input lists of supplies via global computer network from remote client computers acting as the remote communications devices.

70. The computer program according to claim 67, further comprising:
history-based programming for assembling a list of supplies based on a client's past purchasing activities and for communicating the list to the remote communication devices of that client.

71. The computer program according to either claim 67 or 69, further comprising:
confirmation programming to send via the global computer network confirmation messages to the clients' communications devices acknowledging receipt of the list of supplies.

72. The computer program according to claim 67, further comprising:
record-keeping programming to assemble purchasing histories by maintaining a record of clients' supply lists received over a period of time and including at least one routine for determining electronically the apparent frequency and quantity of at least one of the supplies on clients' lists.

73. The computer program according to claim 72, further comprising:
notification programming to forward a notice to a client in anticipation of that client's need for a supply item based on the determined frequency and quantity of the at least one supply on that client's lists.

74. The computer program according to claim 72, further comprising:
automatic-ordering programming for automatically including the at least one of the supplies among the supplies that are offered to purchase based, at least in part, on the determined frequency and quantity of the at least one supply on that client's list.

75. The computer program according to claim 67, further comprising:
selection programming for selecting a supplier based on one of price, delivery time, quality of product and reliability of supplier.

76. The computer program according to claim 67, further comprising:
terms-developing programming for including at further, non-price terms for the delivery of supplies.

77. The computer program according to claim 76, wherein the terms-developing programming includes routines for including at least one of delivery cost, carrier, and delivery schedule.

78. A system for the regular replenishing of supplies including:
(a) a central computer,
(b) a plurality of clients' local communications devices,
(c) a plurality of suppliers' local communications devices,
(d) a computer program for the central computer including:
(i) programming to receive lists of supplies from the plurality of clients' local communications devices and to aggregate like supplies from received lists of supplies,
(ii) further programming to offer, via suppliers' local communications devices, to purchase from suppliers the supplies thus aggregated, and
(iii) additional programming to communicate to the suppliers, via the suppliers' local communications devices, instructions for the delivery of the supplies among clients from whose lists the supplies have been aggregated.

79. The system according to claim 78, wherein the computer program for the central computer further comprises history-based programming for assembling a list of supplies based on a client's past purchasing activities and programming communicating the list to the remote communication devices of that client.

80. The system according to claim 78, wherein the computer program for the central computer further comprises record-keeping programming to assemble purchasing histories by maintaining a record of clients' supply lists received over a period of time and determining the apparent frequency and quantity of at least one of the supplies on clients' lists.

81. The system according to claim 80, wherein the computer program for the central computer further comprises notification programming to forward a notice to a client in anticipation of that client's need for a supply item based on the determined frequency and quantity of the at least one supply on that client's lists.

82. The system according to claim 80, wherein the computer program for the central computer further comprises automatic ordering programming to automatically include the at least one of the supplies among the supplies that are offered to purchase based, at least in part, on the determined frequency and quantity of the at least one supply on that client's list.

83. The system according to claim 78, wherein the client's local communications devices include telephones, and the computer program for the central computer further comprises programming for receiving by interactive voice response the lists of supplies input telephonically from client telephones.

84. The system according to claim 78, wherein the computer program for the central computer further comprises programming for receiving the input lists of supplies via global computer network from remote client computers acting as the remote communications devices.

85. The system according to claim 78, wherein the plurality of client's local communications devices include computerized communications devices.

86. The system according to claim 85, wherein the computerized communications devices that are the clients' local communications devices have supply list preparation programming.

87. The system according to claim 86, wherein the supply list preparation programming includes voice recognition enabling clients to dictate supply purchase lists.

88. The system according to claim 86, wherein the supply list preparation programming includes bar code recognition programming, and the clients' local communications devices include a bar code scanner.

89. The system according to claim 88, wherein the supply list preparation programming includes programming for generating a list of supplies and associated bar codes for use by the bar code scanner.

90. The system according to claim 88, wherein the bar code scanner includes an attached display and associated programming to cause listed items of supplies to appear on the display.

91. The system according to claim 90, wherein the computer program for the central computer comprises programming for sending a confirmation to the clients' local communications devices, and the associated programming for the display attached to the bar code scanner includes programming responsive to the confirmation to indicate the confirmation on the display.

92. The system according to claim 85, wherein the clients' local communications devices include computers connecting with the central computer via global computer network.

93. The system according to claim 92, wherein the computers connecting with the central computer via global computer network have supply list communicating programming adapted to run as background to other, active programs.

94. The system according to claim 78, wherein the plurality of suppliers' local communications devices include computers adapted to connect to the central computer via global computer network.
